(19) United States
(12) Patent Application Publication
(10) Pub. No.: US 2024/0221474 A1
(43) Pub. Date: Jul. 4, 2024

(54) LOSS PREVENTION SYSTEM AND METHOD OF USE

(71) Applicant: Digital Media Vending International LLC, Sebastopol, CA (US)

(72) Inventor: David Ashforth, Windsor, CA (US)

(73) Assignee: Digital Media Vending International LLC, Sebastopol, CA (US)

(21) Appl. No.: 18/398,784

(22) Filed: Dec. 28, 2023

Related U.S. Application Data
(60) Provisional application No. 63/477,518, filed on Dec. 28, 2022.

(51) Int. Cl. G07G 3/00; G06Q 10/087; G06Q 20/18

(52) U.S. Cl. CPC G07G 3/003; G06Q 10/087; G06Q 20/18

(57) ABSTRACT

A system and method for combatting shrinkage in the retail industry which has a computer system, a user interface, a payment acceptor, a receipt generator, a vending machine, an inventory reader, a receipt reader, and a vending machine controller. The inventory reader tracks inventory of the vending machine and communicates the inventory to the computer system, which in turn communicates the inventory to the user via the user interface. A user selects a product for purchase on the user interface and pays via the payment acceptor. The user is provided with a receipt, which is then taken to the receipt reader. Once the receipt reader verifies the receipt, the vending machine controller of the vending machine provides the purchased product to the user.

### CROSS-REFERENCE TO RELATED APPLICATIONS

This application claims the benefit of U.S. Provisional Patent Application No. 63/477,518, filed Dec. 28, 2022, titled “LOSS PREVENTION SYSTEM AND METHOD OF USE”, which is incorporated by reference herein in its entirety.

### TECHNICAL FIELD

The present invention relates to loss prevention, and more specifically, to using vending machines in loss prevention for retailers.

### BACKGROUND ART

Retailers are always looking for new ways to reduce losses, especially preventable losses. Preventable losses are business costs that are caused by deliberate or inadvertent human actions, known in business as “shrinkage”. Shrinkage is typically caused by theft, fraud, vandalism, waste, abuse, or misconduct by employees or customers. In 2021, retail shrinkage in the United States was estimated at $112 billion. See 2023 Retail Security Survey, conducted by the National Retail Federation, https://cdn.nrf.com/sites/default/files/2023-09/NRF_National_Retail_Security_Survey_2023.pdf.

Shrinkage costs only continue to rise every year, leaving retailers to seek ways to combat the losses. There are many loss prevention methods and apparatuses contained in the prior art. Many retailers have resorted to simply putting their inventory behind locked plexiglass, cages, etc. This requires customers to seek out an employee to unlock the cage in order for the customer to obtain the inventory. At this point, the employee can either walk the merchandise up to the checkout or give the merchandise to the customer. Walking the merchandise up to the checkout creates lost time by the employee, while giving the merchandise to the customer prior to paying for it creates the exact problem they have been trying to eliminate.

U.S. Pat. No. 9,697,709 B2 titled, “MERCHANDISE ACTIVITY SENSOR SYSTEM AND METHODS OF USING SAME” provides a system for real-time location services.

However, a method such as this simply is a way to track merchandise. A retailer still needs to have sufficient resources to confront the theft as it is happening.

U.S. Pat. No. 10,937,289 B2 titled, “MERCHANDISE ACTIVITY SENSOR SYSTEM AND METHODS OF USING SAME” also provides a system whereby the retailer is notified when merchandise is removed.

US 2020/0193789 A1 titled “ANTI-THEFT RESPONSE RANDOMIZER” provides systems and methods for “maximizing the deterrence effect on theft.” Again, this prior art simply notifies the retailer or performs other functions when theft is detected, such as filming or turning on a light.

These referenced prior art systems all seek to tackle the problem of shrinkage too late in the process. These are simply tracking methods that allow retailers to track their inventory and alert the retailer when theft has been detected or suspected. Security guards or other means must still be employed in addition to these methods to actually limit shrinkage.

Some retailers have turned to vending machines. Modern vending machines have been around since the early 1880s in England, where they dispensed postcards. Vending machines have historically been used for lower cost items like drinks, candy, toys, etc., but have more recently been used for more expensive items. Vending machines allow a customer to purchase items at the point of sale and obtain the item, all without an employee. Thus, vending machines are very attractive when it comes to combatting shrinkage.

There exists a need for vending machines that allow customers to pay for goods at a kiosk, or other separate location, and then obtain the goods at the vending machine, while allowing the retailer to track their inventory.

None of the prior art fully addresses the problems resolved by the present invention. The present invention overcomes these limitations contained in the prior art by providing a system that eliminates the use of employees to gain access to products, allows customers to easily see the products, tracks the products from the stocking of the vending machine to the sale of the product, allows retailers to track their inventory, securely houses the actual products, and allows customers to only gain access to a product after purchase. The present invention combats shrinkage while also enhancing the customer experience. The present invention provides a sturdy, effective, and easy to use system to combat shrinkage.

Certain embodiments of the invention have other steps or elements in addition to or in place of those mentioned above. The steps or element will become apparent to those skilled in the art from a reading of the following detailed description when taken with reference to the accompanying figures.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The figures illustrating embodiments of the system, if any, are semi-diagrammatic and not to scale and, particularly, some of the dimensions are for the clarity of presentation and are shown exaggerated in the drawing figures.

It is noted that, as used in this specification and the appended claims, the singular forms “a,” “an,” and “the” include plural referents unless expressly and unequivocally limited to one referent. Thus, for example, a reference to “a computer system” includes two or more different computer systems. As used herein, the term “include” and its grammatical variants are intended to be non-limiting, such that recitation of items in a list is not to the exclusion of other like items that can be substituted or other items that can be added to the listed items.

Alternate embodiments have been included throughout, and the order of such are not intended to have any other significance or provide limitations for the present invention.

The term “shrinkage” as used herein refers to preventable losses incurred by businesses/retailers that are caused by deliberate or inadvertent human actions.

The present invention provides a system for combatting shrinkage, comprising at least one computer system; a user interface; a payment acceptor; a receipt generator; at least one vending machine; at least one inventory reader; at least one receipt reader; and at least one vending machine controller, wherein the at least one computer system is connected to the at least one vending machine, wherein the at least one inventory reader tracks inventory of the at least one vending machine and communicates the inventory to the at least one computer system, wherein the at least one computer system provides the inventory contained in the at least one vending machine to the user via the user interface, wherein a user selects a product and purchases the product on the user interface and pays via the payment acceptor, wherein the receipt generator provides the user with a receipt once a product has been purchased, and wherein the user takes the receipt to the at least one receipt reader and the at least one receipt reader reads the receipt and validates the authenticity of the receipt and generates a signal signifying the receipt and the product identified on the receipt and transmits the data to the at least one vending machine controller which locates the product as identified by the at least one receipt reader and dispenses the product to the user.

The present invention further provides a method for combatting shrinkage, comprising the steps of: a computer system generates the availability of products from any number of vending machines located in set parameters; a user selects the desired product or products from a user interface on the computer system, wherein the computing system provides the price of the products and the location of the selected vending machine; the user pays the indicated price; a receipt is generated and provided to the user; the user takes the receipt to the selected vending machine; at least one receipt reader on the vending machine reads the receipt; and at least one vending machine controller located in the vending machine locates the products as indicated on the receipt and dispenses them to the user.

The present invention further provides a system for combatting shrinkage, comprising at least one vending machine; at least one inventory reader; wherein at least one inventory reader tracks the inventory of the at least one vending machine; at least one computer system; wherein the inventory of the at least one vending machine is communicated to the at least one computer system; a user interface; wherein the at least one computer system provides the inventory of the at least one vending machine to the user interface; a payment acceptor; a receipt generator; wherein user selects one or more products to purchase and pays for the products via the payment generator and a receipt is generated via the receipt generator; at least one receipt reader; and at least one vending machine controller, wherein the user takes the receipt to the at least one receipt reader and the at least one receipt reader reads the receipt and validates the authenticity of the receipt and generates a signal signifying the receipt and the product identified on the receipt and transmits the data to the at least one vending machine controller which locates the product as identified by the at least one receipt reader and dispenses the product to the user.

The present invention operates by a user selecting a product or products from the user interface which communicates with the computer system. The computer system generates a price, the user pays, and a receipt is generated by the receipt generator.

Once a product is purchased on the user interface, the product can be marked as reserved in the vending machine in order to ensure that no one else purchases it before the user can provide the receipt to the receipt reader and retrieve the purchased product. The product can be marked as reserved for any amount of time, as determined by the retailer.

The receipt generator is any means by which a receipt is generated and provided to the user. The receipt generated can be a digital receipt, a code, a QR code, a bar code, etc. The receipt can be received by the user by email, text, the user interface, etc.

The user takes the receipt to the vending machine and uses the receipt reader to read the receipt. The vending machine controller locates the product or products as indicated on the receipt and dispenses them to the user.

The vending machines that are part of the system and method of the present invention each may comprise any of a cabinet for housing and dispensing products, an inventory reader, a receipt reader, a locking system, and a vending machine controller, in addition to other parts. The cabinet allows products to be placed at pre-determined positions and dispensed. The inventory reader tracks any of certain information as requested by the owner/operator of the vending machine(s), including, but not limed to, the identity of the person loading the products, date, time, products, location of products placed in the at least one vending machine, number of products, placement of products, etc. Products are scanned, or other means of recording the desired data, by the inventory reader upon being placed into the vending machine(s). The locking system can only be opened by authorized individuals. All information received by the inventory reader is communicated to the store, via cloud or other means, and the computer system(s). The information received by the inventory reader may be communicated to other sources.

The receipt reader comprises a validator processor for reading the receipt and validating the authenticity of said receipt and for generating a signal signifying the receipt and the product identified on said receipt and transmitting the data to the vending machine controller which locates the product as identified by the receipt reader and dispenses the product to the user.

The receipt generated from the computer system is read by the receipt reader, and the purchased item is located by the vending machine controller and dispensed to the user.

The receipt reader may be located on the vending machine, or it may be located separate from the vending machine and communicate with the vending machine by some sort of communication method, such as Bluetooth, wireless, etc.

The vending machines of the present invention are interconnected, whereby one receipt reader can be utilized for multiple vending machines that are placed side by side and interconnected.

The inventory reader of the vending machine(s) is interconnected with the computer system(s). The inventory reader comprises any number of tracking mechanisms contained in, or communicating with, the vending machine. The inventory reader's function is to track the inventory of the vending machine, along with communicating the location of the products and the inventory to the store and/or the computer system. The inventory reader may transmit all data received to a retailer, or other desired party.

The computer system of the present invention tracks all inventory of the vending machines, using information provided by the inventory readers and/or other mechanisms. This ensures that a user does not purchase a product that has already been sold. The computer system also updates the retailer as to the inventory contained in the vending machine(s). Once a product is purchased on a user interface, that information is transmitted to the computer system and it is marked as purchased in the system of the present invention, thereby reserving the purchased product in the selected vending machine even before it is physically obtained by the user. This helps prevent a situation whereby a user purchases a product on the computer system that is available at the time of purchase but is gone from the vending machine once the user goes to redeem the receipt.

The inventory reader, computer system, other components of the present system, or additional components may be used to track inventory from the time it arrives at the retailer to the moment a consumer purchases it.

The receipt of the present invention comprises any number of codes, or other devices/mechanisms, that allow the receipt reader to read the code contained on the receipt and dispense the purchased product to the user. The receipt comprises, including, but not limited to, a code, a barcode, a QR code, etc. The receipt may be a physical receipt, a digital receipt, a code that they enter into the receipt reader, or any other means that allows the receipt to be read/interpreted by the receipt reader.

The computer system of the present invention may comprise any number of devices that communicate with a user interface that allows the user to see the products that are located in the vending machine of the present invention, purchase the product(s), and obtain a receipt. The computer system may comprise, including, but not limited to, a kiosk, a mobile device, a computer, an employee-operated register, or other means.

The user interface of the present invention is any type of device that provides access to the computer system of the present invention. The user interface can be, including but not limited to, a mobile device, a computer, a kiosk, etc. The user interface may be part of the computer system, or it can communicate with the computer system by any necessary means, such as wireless, Bluetooth, the cloud, etc.

The payment acceptor of the present invention comprises any means that allow a user to pay for a product. The payment can be made by credit card, online payment services, cash, etc. In the preferred embodiment, the payment acceptor is accessible via the user interface, and may be part of the user interface. The payment acceptor may be part of the computer system, with the means to accept any form of payment.

The payment acceptor may be such that a user selects a product on the user interface for purchase. The user is provided with some sort of digital certificate, bar code, ticket, or other method that can be taken to a physical kiosk, cashier, or other location whereby the user can pay with physical cash. Once the product is paid for, the receipt is generated, as provided in the present system.

The computer systems are interconnected to the inventory of the store where the vending machine(s) is located and the inventory reader. This can be accomplished by uploading all data to the cloud or other means that allows for the retailer to access the information. This allows the retailer to track the inventory in order to order new inventory when needed and re-stock the vending machine when certain products are running low.

The inventory reader allows a retailer to track all important data relating to products placed in the vending machine(s). Data inputted to and by the inventory reader is transmitted to a cloud-based system, or other means, that allows the retailer to access all data. The inventory reader can communicate directly with the computer system in order to update the listing of products in real-time. This allows a retailer to see exactly which products were placed in the vending machine, by whom, at what time, and the date. This helps combat shrinkage due to employee theft. All products are tracked from the warehouse to the user. Additionally, the locking system can only be opened by authorized individuals, which is tracked.

The system of the present invention allows a store to place virtually any item in the vending machines, while only requiring minimal employees. Employees are not required to scan items at checkout, to unlock the case for users to purchase items, reorganize shelves, etc. Employees simply stock the vending machines and monitor the inventory of same.

The system and method of the present invention may include any of a computer system, a user interface, a payment acceptor, a receipt generator, a vending machine, an inventory reader, a receipt reader, and a vending machine controller, in any combination, along with any number of these elements. These elements may be combined with additional elements in the system and method of the present invention.

The best mode for carrying out the invention has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention.

In the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying drawings are to be interpreted in an illustrative and non-limiting sense.

What is claimed is:

1. A system for combatting shrinkage, comprising:
at least one computer system;
a user interface;
a payment acceptor;
a receipt generator;
at least one vending machine;
at least one inventory reader;
at least one receipt reader; and
at least one vending machine controller,
wherein the at least one computer system is connected to the at least one vending machine,
wherein the at least one inventory reader tracks inventory of the at least one vending machine and communicates the inventory to the at least one computer system,
wherein the at least one computer system provides the inventory contained in the at least one vending machine to the user via the user interface,
wherein a user selects a product and purchases the product on the user interface and pays via the payment acceptor,
wherein the receipt generator provides the user with a receipt once a product has been purchased, and
wherein the user takes the receipt to the at least one receipt reader and the at least one receipt reader reads the receipt and validates the authenticity of the receipt and generates a signal signifying the receipt and the product identified on the receipt and transmits the data to the at least one vending machine controller which locates the product as identified by the at least one receipt reader and dispenses the product to the user.

2. The system for combatting shrinkage of claim 1, wherein the user interface is a user's mobile device.

3. The system for combatting shrinkage of claim 1, wherein the receipt generated by the receipt generator of the computer system is a digital receipt.

4. The system for combatting shrinkage of claim 1, wherein the receipt is a code.

5. The system for combatting shrinkage of claim 1, wherein the at least one inventory reader tracks the identity of the person loading the products, date, time, products, and location of products placed in the at least one vending machine.

6. The system for combatting shrinkage of claim 1, wherein the payment acceptor is part of the user interface and accepts any number of digital payment methods.

7. A method for combatting shrinkage, the steps comprising:
a computer system generates the availability of products from any number of vending machines located in set parameters;
a user selects the desired product or products from a user interface on the computer system,
wherein the computing system provides the price of the products and the location of the selected vending machine;
the user pays the indicated price;
a receipt is generated and provided to the user;
the user takes the receipt to the selected vending machine;
at least one receipt reader on the vending machine reads the receipt; and
at least one vending machine controller located in the vending machine locates the products as indicated on the receipt and dispenses them to the user.

8. The method for combatting shrinkage of claim 7, wherein the user interface is a user's mobile device.

9. The method for combatting shrinkage of claim 7, wherein the receipt generated by the receipt generator of the computer system is a digital receipt.

10. The method for combatting shrinkage of claim 7, wherein the receipt is a code.

11. The method for combatting shrinkage of claim 7, wherein the at least one inventory reader tracks the identity of the person loading the products, date, time, products, and location of products placed in the at least one vending machine.

12. The method for combatting shrinkage of claim 7, wherein the payment acceptor is part of the user interface and accepts any number of digital payment methods.

13. A system for combatting shrinkage, comprising:
at least one vending machine;
at least one inventory reader;
wherein at least one inventory reader tracks the inventory of the at least one vending machine;
at least one computer system;
wherein the inventory of the at least one vending machine is communicated to the at least one computer system;
a user interface;
wherein the at least one computer system provides the inventory of the at least one vending machine to the user interface;
a payment acceptor;
a receipt generator;
wherein user selects one or more products to purchase and pays for the products via the payment generator and a receipt is generated via the receipt generator;
at least one receipt reader; and
at least one vending machine controller,
wherein the user takes the receipt to the at least one receipt reader and the at least one receipt reader reads the receipt and validates the authenticity of the receipt and generates a signal signifying the receipt and the product identified on the receipt and transmits the data to the at least one vending machine controller which locates the product as identified by the at least one receipt reader and dispenses the product to the user.

14. The system for combatting shrinkage of claim 13, wherein the user interface is a user's mobile device.

15. The system for combatting shrinkage of claim 13, wherein the receipt generated by the receipt generator of the computer system is a digital receipt.

16. The system for combatting shrinkage of claim 13, wherein the receipt is a code.

17. The system for combatting shrinkage of claim 13, wherein the at least one inventory reader tracks the identity of the person loading the products, date, time, products, and location of products placed in the at least one vending machine.

18. The system for combatting shrinkage of claim 13, wherein the payment acceptor is part of the user interface and accepts any number of digital payment methods.
